(19) United States
(12) Patent Application Publication
(10) Pub. No.: US 2003/0201675 A1
(43) Pub. Date: Oct. 30, 2003

(54) Magnetically programmable remote switch controller

(76) Inventors: George Alexanian, Fresno, CA (US); Eugene S. Carlson, Fresno, CA (US)

Correspondence Address: MARK D MILLER, KIMBLE, MACMICHAEL & UPTON, 5260 NORTH PALM AVENUE, SUITE 221, FRESNO, CA, 93704, US

(21) Appl. No.: 10/410,417

(22) Filed: Apr. 8, 2003

Related U.S. Application Data
(63) Continuation-in-part of application No. 10/033,059, filed on Nov. 2, 2001, now abandoned.

(51) Int. Cl. H02B 1/24

(52) U.S. Cl. 307/116

(57) ABSTRACT

A simple battery powered programmable remote switch or valve controller is provided that may be sealed inside an environmentally protective enclosure after receiving initial programming. One or more magnetically operable switches electrically connected to said controller are provided inside the enclosure and are capable of being triggered by a magnet on the outside of the enclosure when the magnet is brought into conductive proximity. As a result, initiating programmed operations, performing maintenance functions, changing settings, or interrogating the controller may all be accomplished using a simple magnet without opening the controller enclosure.

This is a continuation of co-pending U.S. Application No. 10/033,059 filed on Nov. 2, 2001, which claims the benefit of U.S. application Ser. No. 09/697,336 filed on Oct. 25, 2000, which claims the benefit of U.S. application Ser. No. 09/315,375 filed on May 18, 1999, now U.S. Pat. No. 6,351,366 which claims the benefit of U.S. application Ser. No. 09/063,871 filed Apr. 20, 1998, now U.S. Pat. No. 5,914,847.

### 1. BACKGROUND OF THE INVENTION

The present invention relates to remote switch controllers, and more particularly to an improved battery powered programmable remote switch controller having extended battery life that is adaptable for use in controlling irrigation valves with magnetic program activation.

### 2. FIELD OF THE INVENTION

Programmable irrigation valve controllers are well known in the art. Such controllers are used to open and close irrigation valves by providing electric current to solenoids located in close proximity to the valves. Relatively large electric currents are required to activate and deactivate such solenoids. Providing this required electricity is a simple matter if an external power source is readily available, such as a power line. However, many controllers must be located at remote field locations where it is impossible or impractical to run a power line or otherwise provide an external power source. Accordingly, programmable battery powered irrigation controllers have been developed.

The most significant limitation of existing battery powered irrigation controllers is battery life. Two voltage levels are generally required by such controllers: a low voltage level (which can be supplied by batteries, e.g. 3.5 volts) to operate the programming circuitry, and a higher voltage level (which can be supplied by a second set of batteries, e.g. 9 volts) or boosted from a single battery to provide the necessary electrical impulses to operate the valve solenoids. The batteries on most existing battery powered controllers must be changed every few months, making them inconvenient to maintain and potentially unreliable to depend on for controlling irrigation cycles. At least one controller has addressed the problem of conserving the low voltage batteries used to operate the computing circuitry. In U.S. Pat. No. 4,423,484 to Hamilton, the microcomputer is turned off between cycles thereby conserving the low voltage batteries. However, the Hamilton controller does not address conservation of the higher voltage batteries used to operate the solenoids.

It is typical for a battery powered irrigation controller to use charging capacitors to operate the valve latching solenoids. These are generally large capacitors of 1000 micro farads or more. Most controllers (including Hamilton) maintain these capacitors in a charged condition, ready for immediate discharge to the solenoid upon receipt of a signal from the microprocessor (see e.g. U.S. Pat. No. 4,718,454 to Appleby). In addition, in most controllers these capacitors have an uninterrupted connection back to the high voltage (e.g. 9, 12 or 18 volts) batteries from which they are charged. Both of these situations reduce the life of the high voltage batteries, and give rise to other potential problems with the controller.

It is known that all charged capacitors leak over time. This places a constant drain on the high voltage batteries to which they are connected. Such leakage significantly increases with temperature increases. Thus, a fully charged capacitor in a controller located in the middle of an unshaded field during the hot summer months can rapidly deplete the high voltage batteries, even when not in use. The larger the capacitor, the larger the leakage current. Also the higher the ambient temperature, the higher the leakage. This leakage is very significant and could be as much as hundreds of microamps. The leakage causes the capacitor to draw on the battery power supply in order to stay fully charged, thereby wasting energy and leading to the frequent need to change batteries without even any solenoid operation. Preventing this leakage would conserve the life of the high voltage batteries.

Battery operated controllers such as Hamilton use the high voltage batteries for operating both the solenoids and the electronics. Since most low power circuits operate from 3 to 5 volts DC, the high voltage batteries must be reduced and regulated, thereby wasting a considerable amount of energy. Alternatively, a low voltage battery may use a boost converter (voltage multiplier) to step up the voltage as in U.S. Pat. No. 5,572,108 to Windes.

In all controllers, the large capacitors are fully discharged in order to operate the valve solenoids. The capacitors are then recharged from the high voltage batteries. At the instant the discharge occurs, current may also be drawn directly from the high voltage batteries themselves, resulting in unnecessary depletion of the high voltage batteries.

Changing the programming for remotely placed valve controllers also poses an ever-present problem. With the change of seasons come changes in the amount irrigation water needed. The additional water required during hot summer months translates to longer open times for irrigation valves. Conversely, the reduced demand for water during the winter season translates to shorter or no open times for such valves. Changes in weather and weather patterns may also affect irrigation valve run times. Also different crops have different water requirements.

All irrigation controllers whether AC, DC or solar powered must be programmed to implement an irrigation schedule. A typical controller includes a front panel with controls that must be accessed in order to program the controller. In order to change the irrigation schedule, the controller must be accessed and a new program entered. Typically this is performed manually using the front panel of the controller. For remotely located controllers, in order to address the ever present need to change irrigation valve run times, the controller includes a radio receiver which remains operational at all times. More sophisticated controllers may use satellite dependent wireless systems. In this way, a signal can be transmitted to the receiver at any time and used to change the programming (run times) of the irrigation valves. However, maintaining a radio receiver in the “on” position over long periods of time requires considerable power, and will rapidly deplete the batteries of a remotely located controller. The receiver in a radio-accessed controller may pick up an errant signal resulting in improper programming. In addition, unless the controller also includes a transmitter (another drain on the batteries), there is no way to confirm the receipt of programming instructions sent via radio. Finally, these sophisticated approaches are often beyond the financial means of ordinary users, not only because of the cost of the equipment but also the personnel required to operate the radio or satellite control.

In many cases, once an initial program is entered into the controller, thereafter only simple subsequent programming commands or changes are generally required. These include, for example, (1) turning the controller on or off; (2) reviewing current programming, (3) activating selected valves or switches to determine proper controller, valve/switch (and sprinkler) operation; (4) shutting down or skipping a valve or switch in a cycle in order to make repairs (such as fixing a broken sprinkler or pipe), (5) reviewing the status of the controller; (6) reviewing or changing run times (e.g. scaling back to save water during rainy periods). These few examples of simple programming may easily describe all of the changes typically made to a controller's programming over the course of an entire year.

Directly accessing a controller in the field to change its programming is typically accomplished by opening the receptacle in which the controller is located and activating switches or plugging a line into the controller to download new programming. Changing the batteries also requires gaining access to the controller in the field. The more quickly the batteries are used up, the more often such access is required. Whenever such access is required, it can be a messy proposition (especially in a cold, dark and/or damp environment), and may introduce unwanted moisture, dirt, dust, debris or other undesirable foreign or corrosive materials that may harm the delicate internal circuitry and components inside the controller. It is therefore desirable to be able to operate a remotely deployed controller in the field while minimizing or avoiding the need for direct physical access to the controller itself.

Detection of magnetic tampering in electricity meters is disclosed in U.S. Pat. No. 4,707,679. If a magnet is brought into conductive proximity of the tamper detection device, it sets a flag and the device seeks to receive instructions from a separate field configuration terminal. If no instructions are received, then the setting of the flag indicates a tamper attempt. However the device cannot be operated or controlled simply by using a magnet.

The need for battery powered programmable remote control switching systems is not limited to irrigation valves. Numerous industrial, utility and commercial applications also involve remote switches which must be reliably turned on and off at scheduled times in order to initiate or terminate processes, open or close gates, etc.

### SUMMARY OF THE INVENTION

The present invention overcomes the disadvantages of prior art remote switching systems by providing a battery powered controller that conserves the life of the battery(ies) which operates the internal controller circuitry as well as the external switches (e.g. latching valve solenoids), and which may be easily programmed without direct physical access to the controller that might otherwise expose the internal circuitry to unwanted foreign material.

In a preferred embodiment, the controller is placed in an enclosure, and direct access is not required in order to initiate, terminate or modify programming. In this embodiment, at least one magnetically activated switch is provided with the controller which can be triggered by a magnet outside of the enclosure. Performing an activation sequence with the magnet (thereby opening and closing the switch in a recognizable pattern) activates programming in the controller without the need to open the enclosure to access the controller.

In one embodiment, two sets of batteries are used in the present invention. A first set of one or more low voltage batteries (typically 3.0 to 3.6 volts) is dedicated to the internal circuitry (e.g. microprocessor). This low voltage powers the microprocessor directly without the need for regulation which would otherwise waste energy. A second set of one or more high voltage batteries is provided which is only used for charging the capacitors which discharge into the remote switches (e.g. to operate the solenoids). This obviates any need to reduce or regulate this battery source for use by the electronic circuitry, so this potential energy loss is avoided. In an alternative embodiment, a single low voltage DC power source can be used to supply the power directly to the microprocessor, and boosted to provide temporary power for solenoid operation.

In the present invention, the large capacitors are not charged until just a few seconds before the solenoid is to be energized. At that point, the microprocessor enables a transistor to turn on and charge such a capacitor. After a measured time interval, depending on the capacity of the capacitor (e.g. about 5 RC time constants), for all intents and purposes, the capacitor becomes fully charged. Following an isolation step (discussed below), a switching device (e.g. relay, triac, transistor, or the like) is used to quickly discharge the capacitor into the switch (e.g. a latching solenoid or latching relay). Thereafter, the capacitor remains discharged waiting for the next operation. Leaving the capacitor uncharged for long periods of time effectively eliminates capacitive leakage current.

The present invention avoids another source of energy waste found in typical battery operation. With existing controllers, when the capacitor discharges, the charging resistor is still connected from the high voltage battery source to the remote switch. This results in a further draw of current from the battery directly by the switch, which also depletes the battery. In the present design, the charging circuit is disabled and isolated by the charging transistor just prior to the capacitive discharge, thereby eliminating this unnecessary power drain. The circuit remains isolated for another measured interval (e.g. approximately 5 RC time constants, a few seconds) before the next operation, at which point the high voltage battery source is again connected to the capacitor for charging followed again by isolation immediately before discharge.

Lithium batteries are recommended as the power source for both the low and high voltage circuits. Lithium batteries have extremely long shelf life (20 years), extremely low self-discharge (less than 1% per year), and are rated for full performance over a wide temperature range up to 85 degrees Centigrade down to −40 degrees Centigrade. Most other types of batteries would self-discharge under typical ambient conditions within a year. Also, lithium batteries have double the energy capacity of alkaline batteries, and are lighter in weight.

The microprocessor is capable of maintaining a set of programming instructions for one or more switches (e.g. valve solenoids) under its control, including at least one default program. The present invention provides a novel approach to changing the programming or initiating one or more default programs which allows the controller to remain insulated from the exterior environment in order to preserve the controller circuitry and maximize the life of the batteries of the controller.

There are many possible remote locations for controllers of the present invention. They can be field mounted (above ground) on a pipe or pedestal, inside a building, whether AC power is available or not. Another possibility in order to avoid damage from climatic elements or from vandalism, such controllers are typically located inside closable receptacles that may be locked for added protection. Such a receptacle may be attached to a wall, placed behind a door, located under a surface, or otherwise conveniently mounted in the vicinity of the switches to be controlled.

In one aspect of the invention for use in irrigation systems, the controller of the present invention may be placed in a closable box that is buried in the ground with its upper surface flush with the surface of the ground around it. The upper surface of such a box is usually a hinged or removable lid which allows access to the interior. The lid may be locked to the box in order to prevent unauthorized access.

In one version of a battery powered controller of the present invention, a small radio receiver is included in the internal circuitry of the controller. However, instead of remaining in a constantly operational condition, the power supply to this receiver is controlled by a magnetic switch which must be activated in order for the receiver to turn “on.” Unless the magnetic switch is closed, the receiver is dormant and does not draw any power. In another version of the present invention which has no radio receiver, all controller operations can be activated or performed using a magnet. Such magnetic operation, discussed more fully below, may be implemented whether the controller is above ground, below ground, solar, AC, or battery powered, with or without radio programming signal capability.

In these embodiments, one or more magnetic switches are located at an edge of the controller circuitry, and the circuitry mounted preferably near a wall, lid or door of the locked receptacle in which the controller is located. Where the controller cannot be mounted directly to a wall, lid or door of the receptacle, one aspect of the invention includes a conductive metallic member that may be provided between the magnetic switch and the edge of the receptacle to provide conductivity over this short gap. This member may take a variety of forms so long as it is made of a suitable conductive metal such as a rod, screw, nail, strip, laminate or other ferrous material. One end of the member is attached in the vicinity of the magnetic switch, and the other end is attached to a nearby wall, lid or door of the locked receptacle. A screw may be used for this purpose by drilling flush it into the wall, lid or door in the very near proximity of the magnetic switch. Such a screw must be made of conductive material, and be of sufficient length to extend from the wall, lid or door to very close proximity with the magnetic switch in order to have a conductive relationship with the switch. In this way, a magnet that is brought near the magnetic switch or the conductive member will cause the magnetic switch to close, thereby activating the radio receiver without opening the receptacle.

In one aspect of the invention, a transmitter may also be provided in the controller circuitry along with the receiver. Power to the transmitter is also controlled by the magnetic switch such that the transmitter is inactive unless the magnetic switch is closed. The transmitter is used to confirm the current programming of the controller, or to confirm receipt of new programming.

In one aspect of the invention, all of the circuitry of the present invention including the batteries, transmitter/receiver, and the magnetic switch are potted (encapsulated) so as to prevent impurities from corroding any of the component parts. This makes the batteries inaccessible. However, because the of the power conserving features of the present invention, the batteries have a very, very long life (on the order of 20 years) such that at the end of that time, the controller unit is simply removed and replaced.

A separate hand held programming unit is also provided for transmitting a program to the controller. This hand held unit includes a data input mechanism (e.g. push buttons, clock, switches, etc.), a display (LCD, LED, lights, or the like) and circuitry to receive, maintain and download the inputted data. The hand held unit is designed to hold numerous different sets of input (i.e., programs containing on/off switching instructions to be downloaded to the controller). The hand held unit also includes transmitter and receiver circuitry, and its own power supply. Importantly, the hand held unit also includes a magnet that is strong enough to trip the magnetic switch on the controller from the outside of the controller receptacle either directly or through the conductive member. The magnet is preferably integrated into the hand held unit, but may be provided separately.

In a typical use, the batteries, circuitry and magnetic switch of the controller are encapsulated (potted), and the encapsulated unit is mounted on or near a wall, lid or door of an environmentally protective receptacle which may be locked. If necessary, a conductive member may be attached to the encapsulated unit near the magnetic switch and extended a short distance to the wall, lid or door of the receptacle. The location of the magnet or conductive member should be marked on the outside of the receptacle.

The user inputs a set of programming instructions to the hand held unit. The user then travels to the controller location, and places the magnet of the hand held unit on the outside of the receptacle in the vicinity of the conductive member or magnetic switch of the controller. This activates the magnetic switch turning on the receiver and, if provided, the transmitter of the controller. The user then causes the hand held unit to download the programming instructions through its transmitter. These instructions are received by the controller in a matter of seconds. If a transmitter is provided on the controller, the hand held unit can then interrogate the controller to confirm the new programming. Once confirmed, the hand held unit is removed from the receptacle and the controller receiver/transmitter shuts off. In this way, not only is very little power required to program the controller, it is also unnecessary to make physical contact with the controller thereby avoiding the introduction of harmful foreign or corrosive materials from the environment. These aspects greatly extend the life of the battery operated controller while also allowing easy changes to be made to the controller programming. In addition, by requiring magnetic activation, external interference is avoided.

In the preferred embodiment of the present invention, at least one embedded program is provided in the controller. For illustrative purposes and by way of example only, and without limiting the scope of the appended claims herein, one such program could provide for serial operation of each switch for a pre-determined time interval (e.g., one minute each in order to “manually” test each valve); another such program could be a custom set of pre-determined switching operations designed as the default set of instructions for the given installation. Other programming such as the six functions enumerated previously could also be provided as imbedded programs, either together or in different combinations.

In this preferred aspect of the invention, a simple magnet is used to initiate most programming and maintenance functions after initial installation and programming. The user simply moves the magnet to a pre-determined location on or near the controller (or its enclosure) where it activates one or more magnetic switches in the controller either directly or through conductive transmission members. Then, by performing one of several pre-set activation sequences involving movement of the magnet into and out of conductive proximity with the magnetic switch(es), a particular program or function may be selected and initiated-all without opening the controller enclosure. Accordingly, in this embodiment there is no need for a radio transmitter or receiver, nor a hand-held unit—only a magnet.

By way of example only, and without limiting the appended claims, a typical activation sequence might call for triggering a magnetic switch on the controller three times within a five-second window, by moving the magnet into and out of conductive proximity with the switch. Such a sequence would be understood by the controller as calling for a particular program or function to be initiated. This could be followed by another sequence to initiate a different program or function. Another example would be simply placing the magnet in the proximity of a magnetic switch on the controller (to close the switch) and leaving it there. After the controller senses that the switch has been closed for a certain time interval (e.g. 15 or 30 seconds), a different program or function is initiated. Other illustrative examples might include tapping the controller with the magnet several times (triggering a magnetic switch with each tap) to select a particular valve or switch to be turned on (e.g. five taps to trigger valve 5), or to specify a number of seconds/minutes (corresponding to the number of taps) that a valve or switch is to be turned on. It is to be appreciated that a large number of different combinations of activation sequences may be employed to trigger the magnetic switch(es) of the controller and initiate various functions and programming. These various sequences could be identified on a sticker on the outside of the controller box, on a laminated key ring card attached to the box, or by some other simple means whereby the user can easily read follow the necessary steps of an activation sequence to initiate the desired functions and programming without opening the controller enclosure.

The preferred embodiment is extremely simple and inexpensive, and could be used with either AC, battery powered or solar powered controllers. It could be used in above ground or below ground (valve box) controllers. With its simplicity of operation, maintenance personnel can quickly and easily turn the controller off or on, make system repairs, test irrigation valves, change the water budget, etc. All of these functions improve the efficiency of the system and help conserve water and eliminate the need to purchase additional hand held programmers to perform simple programming and maintenance functions.

It is therefore a primary object of the present invention to provide a means for performing simple programming and maintenance functions in an irrigation controller, regardless of the means of power supplied to the controller, without the need to access the front panel controls of the controller, and without the use of any radio transmitter or receiver.

It is another primary object of the present invention to provide an improved battery powered programmable remote switch controller having numerous features which extend the life of the controller batteries.

It is also an important object of the present invention to provide a battery powered programmable remote switch controller that is designed to be placed inside an enclosure and accessed without opening the enclosure through one or more magnetically activated switches in said controller, the switches being triggered (closed) by use of a magnet outside the enclosure, such that different activation sequences using the magnet initiate different functions or programs in the controller.

It is another important object of the present invention to provide a battery powered programmable remote switch controller which includes a magnetic switch for activation of an on-board receiver, and a hand held unit with magnet and transmitter for downloading programming to the controller.

It is a further object of the present invention to provide a battery powered programmable remote switch controller which includes at least one magnetic switch and at least one default program, the default program being initiated by an activation sequence performed by the magnet.

It is a further important object of the present invention to extend the life of the batteries in a battery powered programmable remote switch controller by not maintaining its activation capacitors in a fully charged condition at all times.

It is a further important object of the present invention to extend the life of the batteries in a battery powered programmable remote switch controller with circuitry which does not allow each capacitor to be charged until just before it is known to be needed for discharge to activate a switch.

It is a further important object of the present invention to extend the life of the batteries in a battery powered programmable remote switch controller using a load isolation circuit which engages to separate the high voltage batteries from the capacitors immediately prior to discharge of the capacitors.

It is a further important object of the present invention to extend the life of the batteries in a battery powered programmable remote switch controller using a circuit which isolates the capacitor(s) from the high voltage batteries several milliseconds before capacitor discharge, so as not to also draw on the capacitor-charging batteries during the discharge operation.

It is a further object of the present invention to extend the life of the batteries in a battery powered programmable remote switch controller in which the circuitry is essentially dormant in that it does not perform continuous power consuming input sampling, but instead either samples only once a second for several milliseconds, or reads the input at the beginning of a programmed operation or in response to an activation sequence.

It is a further object of the present invention to extend the life of the batteries in a battery powered remote switch controller by providing one or more magnetic switches for activating controller functions or programming, such that the controller is dormant between programmed operations except when the magnetic switches are occasionally activated.

It is a further object of the present invention to minimize spurious, false and/or interfering radio frequency (RF) signals in a battery powered radio programmable remote switch controller by providing a receiver in the controller that is only occasionally activated using a magnetic switch.

It is a further object of the present invention to allow a battery powered radio programmable remote switch controller to be locked inside a receptacle where it is protected from the outside environment and from vandalism by providing a controller that may be activated from the exterior of the receptacle using one or more magnetic switches.

It is a further object of the present invention to allow a battery powered radio programmable remote switch controller to receive programming while locked inside a protective housing by providing a receiver in the controller that may be activated from the exterior of the housing using a magnetic switch, and by providing a hand held unit with magnet and transmitter for, respectively, switching on the receiver and downloading programming.

It is a further object of the present invention to provide speedy radio programming of a battery powered remote switch controller.

It is a further object of the present invention to minimize the possibility of accidental improper programming of adjacent battery powered radio programmable remote switch controllers by providing a separate magnetic switch on each controller for individual activation of the receiver of each controller.

It is a further object of the present invention to provide a battery powered programmable remote switch controller in which the circuitry is encapsulated (potted or otherwise sealed) so as to prevent impurities from corroding any of the component parts, and to minimize exposure to electrostatic discharge.

It is a further object of the present invention to provide a battery powered programmable remote switch controller which uses lithium batteries for both the high and low voltage batteries because of their greater reliability and long life.

It is a further object of the present invention to provide a battery powered programmable remote switch controller which is adaptable for use for controlling irrigation valves.

It is a further object of the present invention to provide a battery powered programmable remote switch controller which is adaptable for use for controlling industrial, commercial, or utility switches or controls.

Other objects of the invention will be apparent from the detailed descriptions and the claims herein.

### BRIEF DESCRIPTION OF THE DRAWINGS

FIG. 1 is block diagram showing the general configuration of the battery powered controller of the present invention.

FIG. 2 is a circuit diagram of the battery powered controller of the present invention including receiver and transmitter circuitry.

FIG. 3 is a circuit diagram of the battery powered hand held programming unit of the present invention.

FIG. 4 is a cross sectional schematic side view of an example environment for a controller of the present invention adapted for controlling irrigation valves. This figure also illustrates the hand held unit with a magnet that has been placed in conductive relationship with the magnetic switch of the controller.

FIG. 5 is a cross sectional side view of an example environment for the controller of the present invention illustrating an alternative embodiment of the conductive member.

FIG. 6 is a chart showing the charge and discharge of a large capacitor of the present invention over time.

FIG. 7 is an environmental view of a pedestal-mounted enclosure holding a magnetically operated controller of the present invention.

### DETAILED DESCRIPTION OF THE DRAWINGS

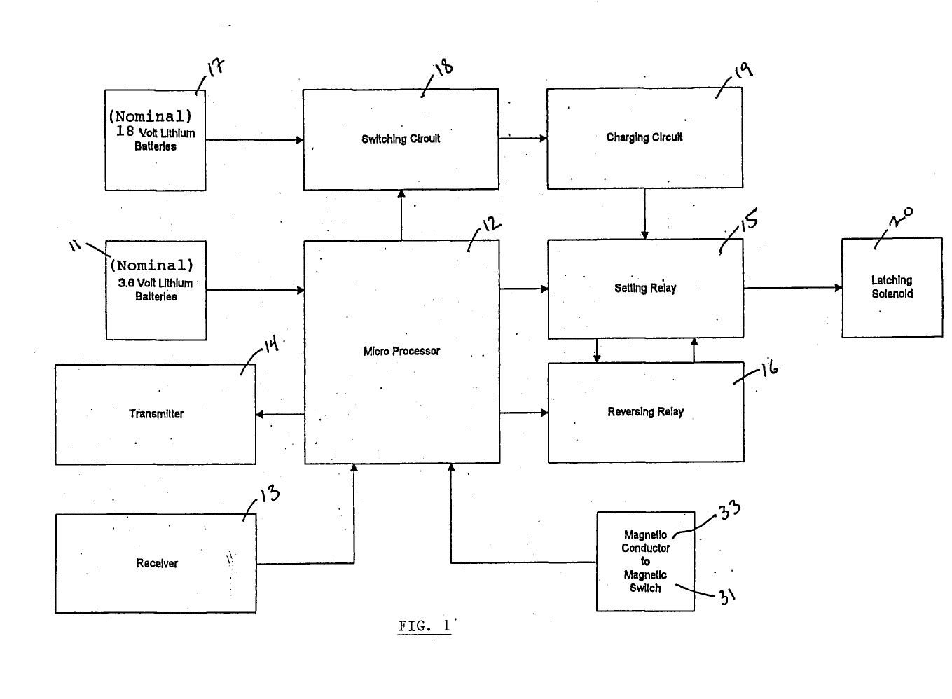

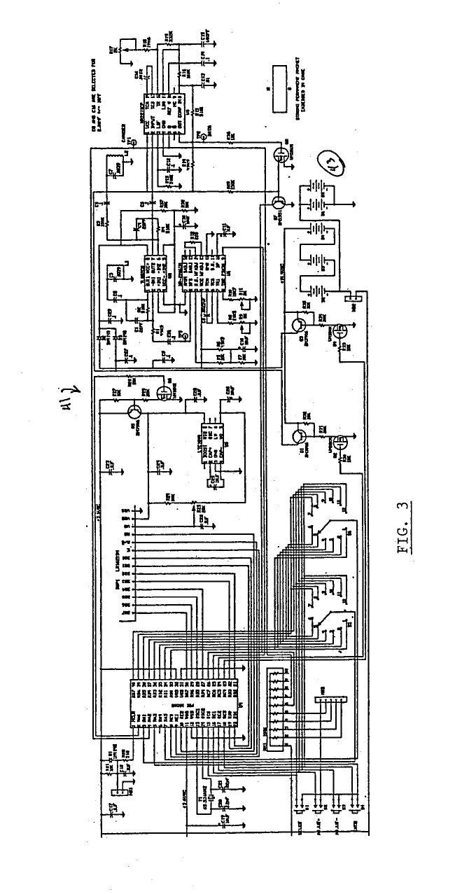

Referring to the drawings wherein like reference characters designate like or corresponding parts throughout the several views, and referring particularly to FIGS. 1, 2 and 3, it is seen that the invention includes a microprocessor 12 powered by a source 11. Source 11 may be made up of at least one battery, preferably a lithium battery of approximately 3.6 volts. Although the following description refers to operation of a single capacitor and an irrigation valve solenoid, the invention may be easily adapted to operate multiple capacitors and multiple solenoids or multiple remote switches while maintaining the important power saving features described herein.

The microprocessor 12 receives programming from the receiver 13, as discussed below. Microprocessor 12 controls a first relay 15 (K1) which is used to send a setting or activation discharge from a large capacitor 19 (C1) in the controller to a remote switch 20 (e.g. a solenoid, to open an irrigation valve). It also controls a second relay 16 (K2) which is used to send a reverse or de-activation discharge from large capacitor 19 to the remote switch 20 (e.g. a solenoid to close a valve).

Microprocessor 12 also controls a switching circuit 18 (using transistors Q1 and Q2) between the high voltage battery source 17 (if an AC or DC power source is available, it can be used instead of battery source 17) and the large charging capacitors such as 19. The voltage of battery source 17 is preferably 14.4, but may be set at any suitable level. Two functions are performed by this circuit under control of the microprocessor. The first function is to delay the charging of capacitor 19 until a given interval just before it is to be discharged to the switch or solenoid 20. The second function is to isolate the charging battery source 17 from the recently-charged capacitor 19 immediately prior to discharge.

Input programming is provided to microprocessor 12 from receiver 13. This programming may include such things as identification of the switch(es) to be controlled (i.e. capacitors to be discharged), start and stop time(s), run time(s), selection between seconds, hours and/or minutes, automatic or semi-automatic operation, etc.

The microprocessor 12 reads the input from the receiver 13. This is only performed at the beginning of a programmed operation, or at infrequent intervals (e.g. once a second for approximately 20 milliseconds). During the remainder of the time, the microprocessor is dormant and only consuming a few microamps from low voltage battery source 11 in order to sustain the programming in RAM memory in the microprocessor. Meanwhile, capacitor 19 is left in an uncharged state. Reading the input tells the microprocessor what function is to be performed when, according to the most recent program settings from the receiver.

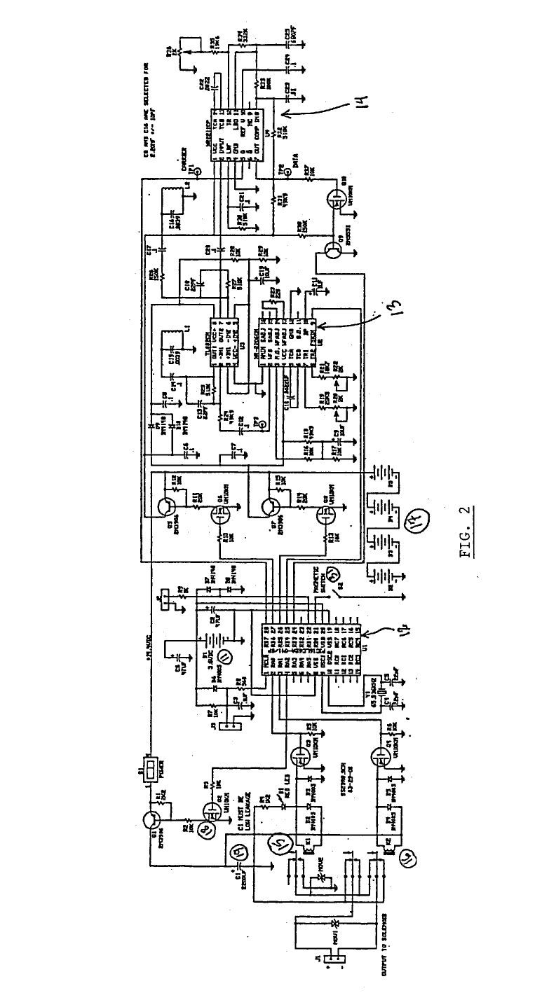

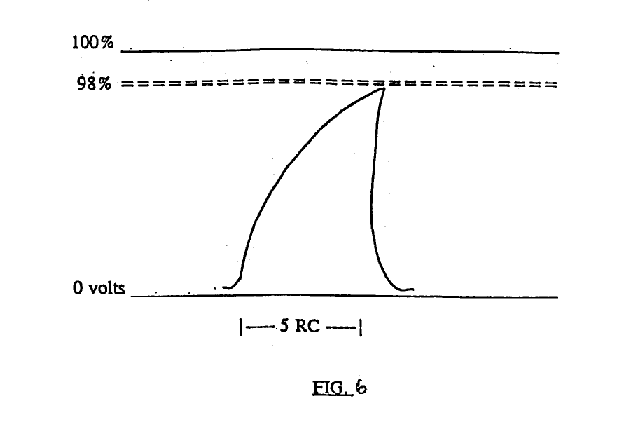

According to the programming or sampling and its internal clock, the microprocessor is able to detect that a programmed operation (activation or deactivation) is upcoming. Approximately 5 seconds (5 RC) before such an operation is to occur, the microprocessor sends a signal (e.g. from pin 4 (see FIG. 2)) to transistor Q2 causing transistor switch Q1 to make the connection between the high voltage battery source 17 and capacitor 19. This causes capacitor 19 to become charged (see FIG. 6). Then, just a few milliseconds before the time for discharging capacitor 19, the microprocessor sends a second signal to turn off transistors Q1 and Q2 thereby isolating the high voltage battery source 17 from capacitor 19. Almost immediately thereafter, capacitor 19 is discharged to the remote switch (e.g. solenoid 20). Capacitor 19 remains in a discharged state until just before the next time a programmed operation is to occurs. At that time, the above process is repeated for that operation, etc.

Microprocessor 12 also controls whether the charge sent to the switch/solenoid is an activation pulse (to open the solenoid) or deactivation pulse (to close the solenoid) by using relay 15 (K1) and double pole reversing relay 16 (K2). Solid state switching mechanisms could be used in place of relays K1 and K2. A signal from the microprocessor (e.g. pin 2 as shown in FIG. 2) to transistor Q3 operates relay K1 causing a direct charge to be sent via relay K1 to the remote switch (e.g. to open the solenoid 20). Signals from the microprocessor (e.g. pins 2 and 3 as shown in FIG. 2) to transistors Q3 and Q4 operate both relays K1 and K2, causing a reverse charge to be sent via relay K1 and double pole reversing relay K2 to the remote switch (e.g. to close the solenoid 20).

Multiple remote switches (e.g. solenoids 20) can be operated by the same controller by providing duplicate sets of circuitry, each set operating a different remote switch 20 using its own capacitor 19, transistors Q1-Q4, and relays K1 and K2. When multiple capacitors 19 are provided, each may have a different capacitance depending upon the level of discharge desired for the remote switch/solenoid associated with the given capacitor. Each duplicate circuit will require its own initiating pin on the microprocessor 12 (e.g. pin 4), and a pair of additional pins (e.g. pins 2 and 3) to control the polarity of the discharge. For controlling large numbers of switches/solenoids, a larger microprocessor or multiple microprocessors may be employed in the controller.

A receiver circuit 13 is provided in one embodiment of the controller for receiving data input to be used by the controller. Power to the receiver is supplied from source 17 which is controlled by a magnetic reed switch 31. When a magnet or magnetic field is brought into conductive relationship with switch 31, it closes thereby supplying power to the receiver circuit. Otherwise (which is most of the time), the receiver circuit is dormant and does not drain power, thereby providing a significant savings in power and prolonging the life of the batteries. This also prevents the reception of misdirected radio signals which might otherwise confuse the programming to the controller. In one aspect of this embodiment, a transmitter circuit 14 may also be provided in the controller. Power to transmitter 14 is also controlled by magnetic switch 31 so that it is dormant most of the time, and only “wakes up” when the receiver does.

A separate hand held programming unit 41 is also provided for radio downloading of programming to the controller. This unit includes its own power supply 43, transmitter circuitry 45, and receiver circuitry 47. Data input devices 49 are provided on unit 41 and may be in the form of push buttons, switches, a rotatable dial (clock), or any combination of these or other suitable devices for providing programming to the unit. A data/programming display is also provided on unit 41 in the form of LCD, LED, lights, or the like. Unit 41 is capable of holding multiple programs. In this way, the user can input several different programs into the unit in advance, and then select the desired program to be downloaded in the field.

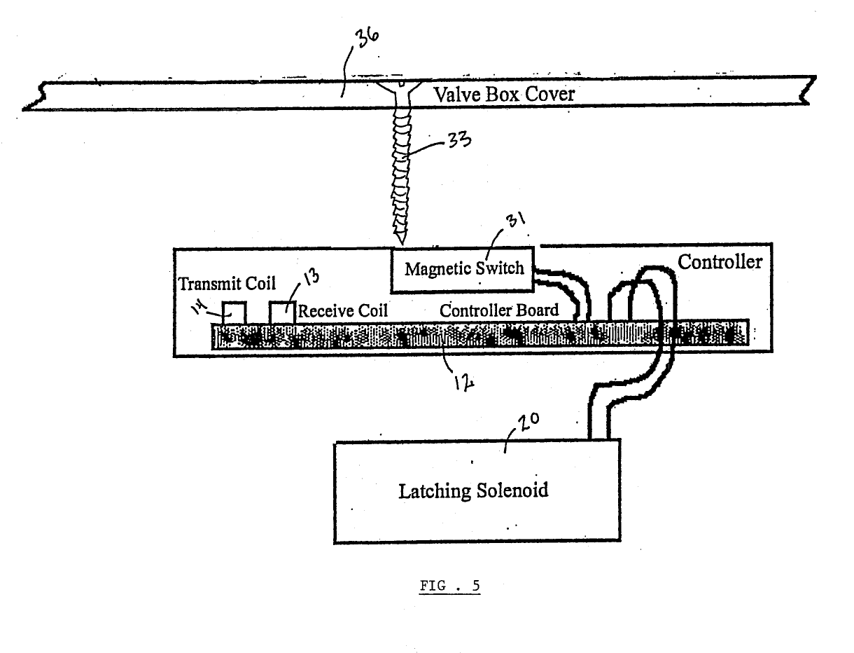

Importantly, a magnet 44 is provided with programming unit 41. Magnet 44 is used to activate (close) magnetic switch 31 either directly by being brought into conductive relationship with switch 31, or indirectly by being brought into conductive relationship with member 33 that is associated with switch 31. In one aspect of the invention shown in FIG. 5, member 33 is a conductive screw that is drilled through the lid of the enclosure such that the screw head is flush with the lid, and the body of the screw is in close proximity (conductive relationship) with switch 31. By activating switch 31, the receiver (and transmitter) of the controller are activated so that radio downloading of programming may be accomplished. Assuming that the programming has been previously input into unit 41, the desired program is simply selected and downloaded taking only a few seconds. If the transmitter circuit is provided on the controller, unit 41 may interrogate the controller and learn in another few seconds whether the download was successful. Since the download and interrogation steps can be accomplished in a matter of seconds, the drain on the controller batteries is equally brief, thereby greatly prolonging the life of the controller batteries.

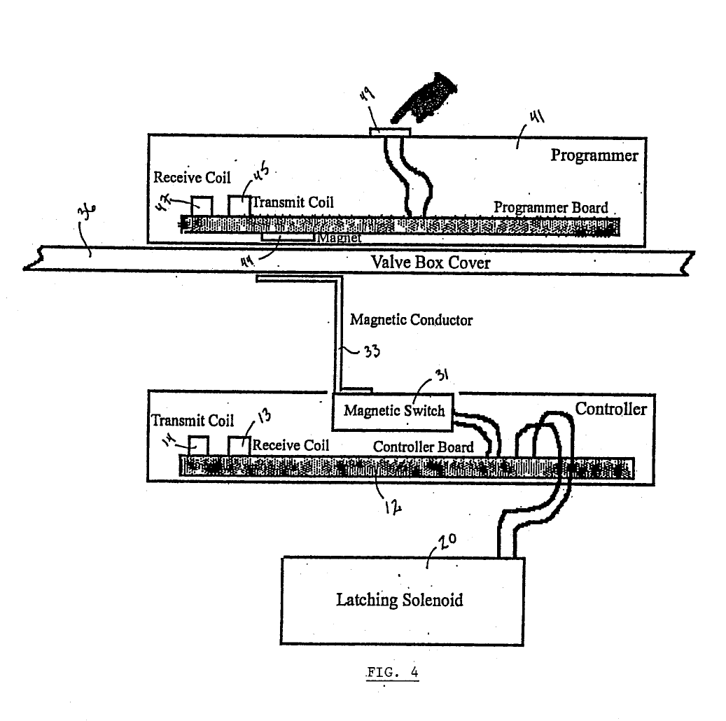

Magnet 44 is preferably integrated into the housing of unit 41 (as shown in FIG. 4), but may be provided separately if so desired. If the magnet is separate, unit 41 must be brought into close proximity with the controller for radio programming to be received. If the magnet is attached to unit 41, bringing the magnet close enough to trip the magnetic switch also brings unit 41 close enough for radio programming to be easily received. When magnet 44 closes magnetic switch 31, there is a time delay during which programming may be downloaded to the controller and verified as described previously. After the time delay, if no programming has been downloaded, the controller automatically initiates the default program. The default program operates only while the magnetic switch 31 is activated; thus, removal of magnet 44 will stop the default program.

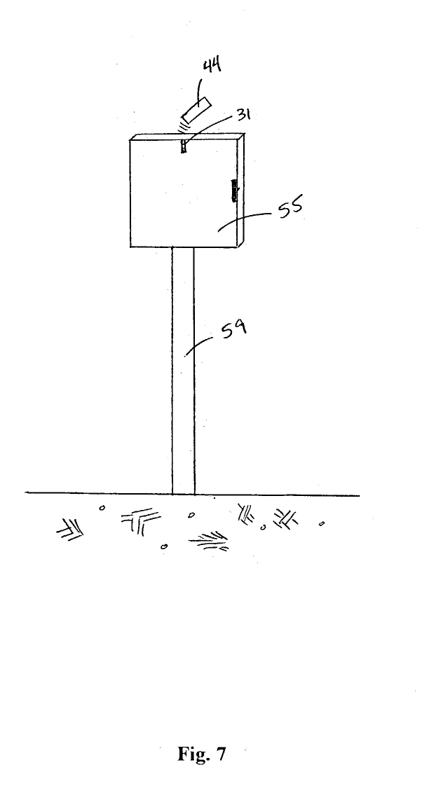

In a very simple alternative embodiment, one or more imbedded programs are provided in the controller. The controller is manually programmed when it is installed, and then placed inside an enclosure 55. The enclosure 55 may be placed on a pedestal 59 as shown in FIG. 7, mounted above ground (e.g. on a pole or wall) or mounted below ground (e.g. in a buried box). One or more magnetic switches 31 inside the enclosure are electrically connected to the controller that may be triggered (closed) by use of a magnet 44 from outside the enclosure. The controller of this embodiment has no radio receiver or transmitter, and the hand-held unit is eliminated. Only a magnet 44 is required. In the non-activated state, magnetic switches 31 are open providing no signal to the controller. In order to initiate one of the embedded programs, or to change the initial programming of the controller, an activation sequence is performed using the magnet 44. In particular, the movement of the magnet 44 into and out of conductive proximity with the one or more switches 31 closes and opens, respectively, switches 31. Different sequences of taps by the magnet 44 (which close and open magnetic switches 31) are used to initiate different programs or change the initial programming in the controller.

For illustrative purposes and by way of example and without limiting the scope of the appended claims, some possible activation sequences include:

a. An initial magnetic activation having a set duration (e.g. 5 seconds) may be used to prepare the controller for further action, i.e. a “wake up” instruction for a controller that is otherwise dormant as it waits for time(s) to be reached to initiate existing programmed operations.

b. Within or at the end of the initial activation time, the controller may provide a status signal, such as a single beep if it is currently “on” and two beeps if it is “off.”

c. If the controller is not currently performing a programmed function, leaving the magnetic switch closed for a longer period of time (e.g. 15 or 30 seconds) may initiate a test cycle where every assigned station/switch is activated for a pre-set time interval to allow for checking and maintenance.

d. If the controller is currently performing a programmed function, leaving the magnetic switch closed for such a period of time (e.g. 15 or 30 seconds) would result in stopping that current operation.

e. After the initial activation time (step “b” above), removing the magnet and then returning it for another short time period (e.g. 5 seconds) will result in toggling the current status of the controller. Thus, if the controller was “off,” this action will turn it back “on” (to resume normal programmed operations), and if the controller was “on” this action will turn it “off.” This instruction could be used to turn off an irrigation valve controller during winter months or prolonged rainy periods.

f. In order to budget irrigation time in valve controllers (proportionally reducing or increasing the time on each station), following the initial activation step (step “b” above), each subsequent short tap (placement and removal) of the magnet 44 would be interpreted by the controller as, for example, increasing or decreasing the proportional run time by 10%. In this example, two taps would reduce the run time by 20% such that if station 1 was previously set to be open for 20 minutes, two taps change this to 16 minutes.

It is to be appreciated that numerous other different sequences could be used to “reset” to original programming, to review existing programming, or to operate selected switches (solenoid/valves), etc., and that different combinations of programs and sequences may be provided to allow a wide range of controller flexibility. Testing controller, valve and sprinkler operations are the most common maintenance functions required for irrigation controllers. Adjusting the station watering time budgets and checking and changing the status of the controller are the most common programming changes during the year. Accordingly, in this embodiment, once initially programmed, most controller functions can be performed using a magnetic activator.

In a variation of this alternative embodiment, the controller has unchangeable custom programming and a default program. The custom programming operates unless a magnet 44 trips the magnetic switch 31. When this occurs, the default program is initiated and operates so long as the magnetic switch 31 is activated. Upon removal of the magnet 44, the custom programming resumes.

It is preferable that power to the printed circuit board and/or microprocessor 20 be provided using one or more nominally 3.6 volt battery(ies) 11. Battery source 11 may be of any suitable size such as AA, AAA or smaller, preferably lithium based. Lower voltage batteries may be provided for microprocessors 20 requiring less power. Power to capacitors 19 is preferably provided from a separate source 17 which may be one or more battery(ies) providing nominally 18 volts during the capacitor charging operation; however, a single higher voltage power source 17 may be used to provide high voltage power to capacitors 19, and low voltage power to the microprocessor 20. Each capacitor 19 (C1 in FIG. 2) should have a capacity of between approximately 1000 and 2500 micro farads (μF) at 25 volts, preferably 2200 μF at 25 volts.

The preferred delay time before each capacitor is allowed to be charged is approximately 5 seconds, although a longer time interval may be employed (e.g. 10 seconds) so long as it is reasonably close to the time for discharge so that leakage is minimized. The 5 time constant interval generally allows the 2200° F. capacitor 19 to reach a 98% charge from the power supply 17 before it is discharged, thereby avoiding any leakage.

The capacitor-charging battery source 17 should be isolated from the capacitors at some time prior to discharge of the capacitors. Although this isolation may be performed at any time before discharge, the preferred time interval is approximately 31 milliseconds.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

In particular, it should be noted that although the diagram of FIG. 2 shows circuitry for operation of a single capacitor and remote switch, this circuitry can be easily adapted for use in controlling multiple capacitors and switches while maintaining the same power saving features of the invention (maintaining capacitor in discharged condition until just seconds prior to discharge, isolation of capacitor from power source immediately prior to discharge, quiescent microprocessor, etc.).

What is claimed is:

1. A control unit for operating at least one switch comprising a controller placed inside an environmentally protective enclosure having at least one embedded program stored therein for controlling the at least one switch, at least one magnetically operable switch electrically connected to said controller and located inside said enclosure that is capable of being triggered by a magnet on the outside of said enclosure when said magnet is brought into the conductive proximity of said at least one magnetically operable switch, and a hand held magnet for triggering said at least one magnetically operable switch.

2. The controller of claim 1 wherein at least one conductive metallic member is provided with each of said magnetically operable switches to increase the range of conductive activation of each of said switches.

3. The controller of claim 2 wherein said enclosure is made of material which allows the transmission of a magnetic field therethrough, and each metallic member extends between each of said magnetically operable switches and an inside edge of one of the group consisting of a wall, a lid, and a door of said enclosure.

4. A method for activating at least one imbedded program stored in a controller comprising the steps of:
a. bringing a magnet into conductive proximity with at least one magnetically operable switch in said controller;
b. performing an activation sequence using said magnet to initiate a selected embedded program of said controller.

5. The method of claim 4 wherein the performance of said activation sequence includes moving said magnet into and out of the conductive proximity of said at least one magnetically operable switch in a particular sequence within an established time frame.

6. The method of claim 5 wherein the performance of said activation sequence includes leaving said magnet in the conductive proximity of said at least one magnetically operable switch for an established time period.

7. The method of claim 5 wherein said controller is provided inside an environmentally protective enclosure that is made of material which allows the transmission of a magnetic field therethrough.

8. The method of claim 7 wherein at least one conductive metallic member is provided with each of said magnetically operable switches to increase the range of conductive activation of each of said switches.

9. The method of claim 8 wherein each metallic member extends between each of said magnetically operable switches and an inside edge of one of the group consisting of a wall, a lid, and a door of said enclosure.

10. A method for operating a dormant remotely-located battery-powered controller having at least one embedded program stored therein comprising the steps of:
a. initially programming the controller;
b. placing the controller in an environmentally protective enclosure that is made of material which allows the transmission of a magnetic field therethrough;
c. bringing a magnet into conductive proximity with at least one magnetically operable switch in said controller to awaken said dormant controller; and
d. thereafter performing an activation sequence using said magnet to initiate a selected embedded program of said controller.

11. The method of claim 10 wherein at least one conductive metallic member is provided with each of said magnetically operable switches to increase the range of conductive activation of each of said switches, each such member extending between each of said magnetically operable switches and an inside edge of said enclosure.

12. The method of claim 11 wherein the performance of said activation sequence includes moving said magnet into and out of the conductive proximity of said at least one magnetically operable switch in a particular sequence within an established time frame.
